(19) United States
(12) Patent Application Publication
(10) Pub. No.: US 2014/0125647 A1
(43) Pub. Date: May 8, 2014

(54) LIQUID CRYSTAL DISPLAY DEVICE AND METHOD OF DRIVING THE SAME

(71) Applicant: LG DISPLAY CO., LTD., Seoul (KR)

(72) Inventors: Dong-Su Shin, Yangpyeong-gun (KR); Min-Jic Lee, Paju-si (KR)

(73) Assignee: LG DISPLAY CO., LTD., Seoul (KR)

(21) Appl. No.: 14/069,596

(22) Filed: Nov. 1, 2013

(30) Foreign Application Priority Data
Nov. 6, 2012 (KR) 10-2012-0125037

(51) Int. Cl. G09G 3/36; G06F 1/32

(52) U.S. Cl. CPC G09G 3/3696; G06F 1/32
USPC 345/212; 345/87

(57) ABSTRACT

A liquid crystal display device includes m/2 data lines and 2n gate lines that intersect each other to define m×n sub-pixels which have first to fourth colors and are arranged in a stripe form. A first pixel, including first to fourth sub-pixels, and a second pixel, including fifth to eighth sub-pixels, are alternately arranged in column and row directions between first and second gate lines such that the first to eighth sub-pixels are arranged in two columns between every two data lines. Connection between the first sub-pixel and the first data line, between the second and third sub-pixels and the second data line, between the fourth and sixth sub-pixels and the third data line, between the fifth and eighth sub-pixels and the fourth data line, and between the seventh sub-pixel and the fifth data line is accomplished.

This application claims the benefit of priority of Korean Patent Application No. 10-2012-0125037, filed on, Nov. 6, 2012, which is hereby incorporated by reference as if fully set forth herein.

### BACKGROUND

1. Field of the Disclosure

The present disclosure relates to a liquid crystal display device and a method of driving the same.

2. Discussion of the Related Art

A liquid crystal display device is configured to display an image by regulating light transmittance of dielectric anisotropic liquid crystals using an electric field.

Typically, a liquid crystal display device includes a liquid crystal panel in which a plurality of pixels is arranged in a matrix form, a drive circuit to drive the liquid crystal panel, and a backlight unit to emit light to the liquid crystal panel.

As liquid crystal display devices are diversified in product groups and are increasingly propagated, liquid crystal display devices to achieve greater size, smaller thickness, higher resolution, and lower power consumption have been studied.

### SUMMARY

A liquid crystal display device, m/2 data lines and 2n gate lines intersect each other to define m×n sub-pixels, the sub-pixels have first to fourth colors and are arranged in a stripe form, a first pixel including first to fourth sub-pixels and a second pixel including fifth to eighth sub-pixels are arranged between a first gate line and a second gate line, the first and second sub-pixels are arranged between a first data line and a second data line, the third and fourth sub-pixels are arranged between the second data line and a third data line, the fifth and sixth sub-pixels are arranged between the third data line and a fourth data line, and the seventh and eighth sub-pixels are arranged between the fourth data line and a fifth data line, the first sub-pixel is connected to the first data line, the second and third sub-pixels are connected to the second data line, the fourth and sixth sub-pixels are connected to the third data line, the fifth and eighth sub-pixels are connected to the fourth data line, and the seventh sub-pixel is connected to the fifth data line, and the first and second pixels are alternately arranged in a column direction and alternately arranged in a row direction.

In another aspect, a method of driving a liquid crystal display device, includes driving m×n sub-pixels arranged in two columns between every two data lines by sequentially supplying scan pulses to 2n gate lines and supplying data voltages to m/2 data lines in synchronization with the scan pulses, the sub-pixels having first to fourth colors and being arranged in a stripe form, wherein driving of the m×n sub-pixels include driving a first pixel including first to fourth sub-pixels between first and second gate lines, and driving a second pixel including fifth and eighth sub-pixels between the first and second gate lines, wherein the first and second sub-pixels are arranged between a first data line and a second data line, the third and fourth sub-pixels are arranged between the second data line and a third data line, the fifth and sixth sub-pixels are arranged between the third data line and a fourth data line, and the seventh and eighth sub-pixels are arranged between the fourth data line and a fifth data line, wherein the first sub-pixel is connected to the first data line, the second and third sub-pixels are connected to the second data line, the fourth and sixth sub-pixels are connected to the third data line, the fifth and eighth sub-pixels are connected to the fourth data line, and the seventh sub-pixel is connected to the fifth data line, and wherein the first and second pixels are alternately arranged in a column direction and alternately arranged in a row direction.

It is to be understood that both the foregoing general description and the following detailed description of the present invention are exemplary and explanatory and are intended to provide further explanation of the disclosure as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the disclosure. In the drawings:

FIG. 1 is a view showing a configuration of a liquid crystal display device according to an embodiment of the present invention;

FIG. 2 is a plan view showing a liquid crystal panel 10 shown in FIG. 1;

FIG. 3 is an explanatory view of a method of driving the liquid crystal panel 10 shown in FIG. 2; and

FIGS. 4A to 4C are plan views showing the case in which the liquid crystal panel 10 according to the embodiment displays a monochromic pattern.

### DETAILED DESCRIPTION OF THE EXEMPLARY EMBODIMENTS

Hereinafter, a liquid crystal display device and a method of driving the same according to an embodiment of the present invention will be described in detail with reference to the accompanying drawings.

In the embodiment, a liquid crystal panel is driven via a Double Rate Driving (DRD) method and a Z-inversion method to reduce the number of output channels of a data drive circuit 12 and power consumption. In addition, in the embodiment, sub-pixels having first to fourth colors are provided, which achieves better light transmittance and brightness than a configuration in which sub-pixels have first to third colors.

For reference, in the DRD method, m×n sub-pixels are driven using m/2 data lines and 2n gate lines, which reduces the number of output channels of a data drive circuit owing to a reduced number of data lines. Next, in the Z-inversion method, data voltages having different polarities are applied to proximate data lines for a first frame period, and two columns of sub-pixels share a single data line for zigzag connection, which enables driving of sub-pixels in dot-inversion and data drive circuit line-inversion manners, resulting in reduced power consumption of a data drive circuit.

However, note that arranging the sub-pixels having first to fourth colors in a stripe form and driving the sub-pixels via the DRD method and the Z-inversion method may cause vertical or horizontal line dimming because the same polarity is repeated vertically or horizontally in a monochromic pattern. The embodiment suggests a configuration to prevent line dimming even in the case in which sub-pixels having first to fourth colors are arranged in a stripe form and driven via the DRD method and the Z-inversion method.

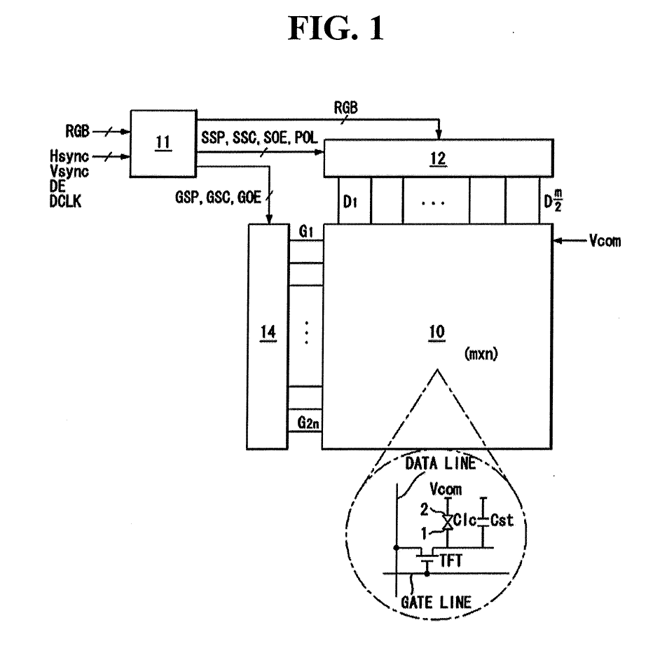

FIG. 1 is a view showing a configuration of a liquid crystal display device according to an embodiment of the present invention.

The liquid crystal display device exemplarily shown in FIG. 1 includes a liquid crystal panel 10, a timing controller 11, a data drive circuit 12, and a gate drive circuit 14.

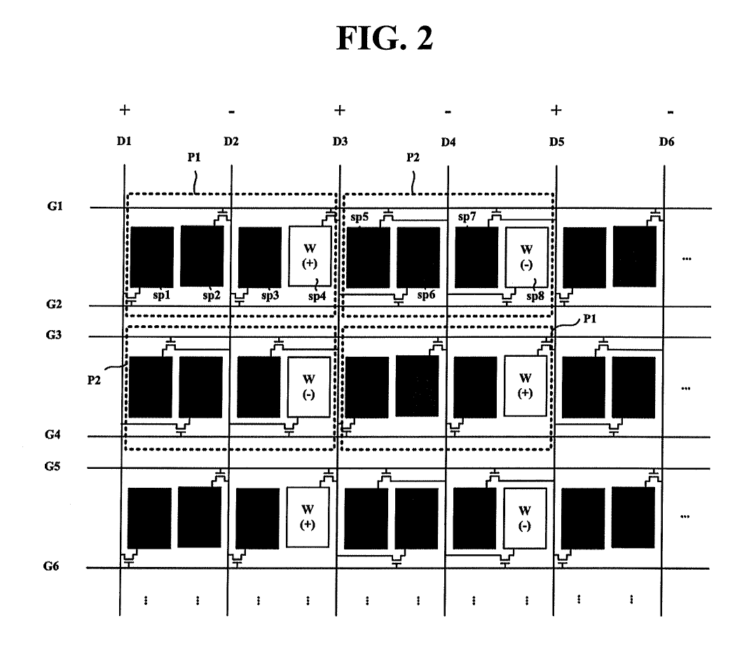

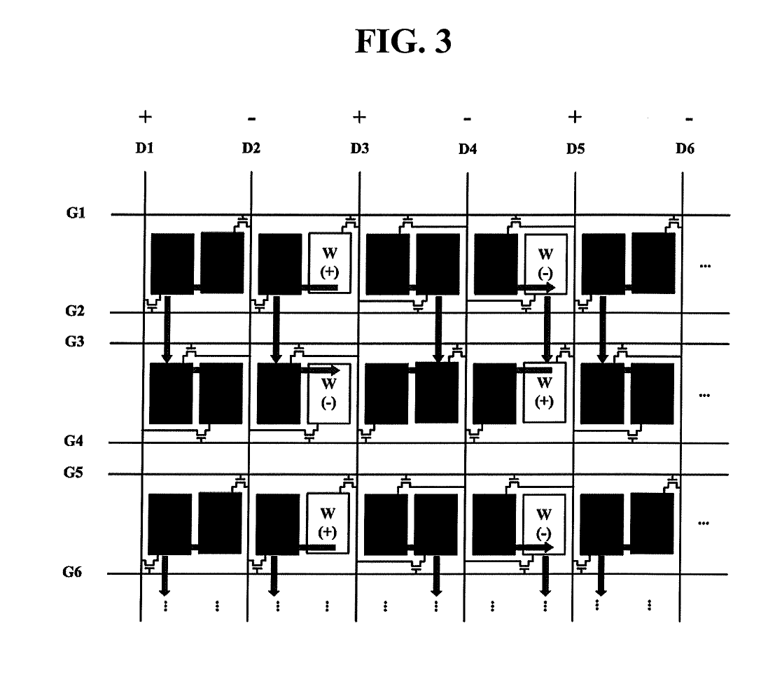

The liquid crystal panel 10 includes a liquid crystal layer formed between two glass substrates. The liquid crystal panel 10 includes m×n sub-pixels arranged in a matrix form via an intersection configuration of m/2 data lines D1 to Dm/2 and 2n gate lines G1 to G1n (n being a natural number), and is driven via a DRD method and a Z-inversion method. The liquid crystal panel 10 will hereinafter be described in greater detail with reference to FIGS. 2 and 3.

The timing controller 11 generates data control signals to control the operation timing of the data drive circuit 12 and gate control signals to control the operation timing of the gate drive circuit 14 using timing signals supplied from a system (not shown), such as, for example, a horizontal synchronization signal Hsync, vertical synchronization signal Vsync, data enable signal DE, dot-clock DCLK. In addition, the timing controller 11 realigns digital video data RGB supplied from the system to conform to resolution of the liquid crystal panel 10, and supplies the same to the data drive circuit 12.

The data control signals may include a source start pulse SSP that indicates a sampling beginning point of digital video data RGB in the data drive circuit 12, a source sampling clock SSC that indicates latch operation of digital video data RGB in the data drive circuit 12 based on a rising edge or falling edge, a source output enable signal SOE that indicates output of the data drive circuit 12, and a polarity control signal POL that indicates the polarity of data voltage to be supplied to the sub-pixels of the liquid crystal panel 10, for example.

The gate control signals may include a gate start pulse GSP that indicates a scan beginning horizontal line for a first vertical period during which a single screen is displayed, a gate shift clock signal GSC that is a timing control signal input to a shift register in the gate drive circuit 14 to sequentially shift the gate start pulse GSP, the gate shift clock signal GSC being generated at a pulse width corresponding to an on-period of TFTs, and a gate output enable signal GOE that indicates output of the gate drive circuit 14, for example.

The data drive circuit 12 latches digital video data RGB under control of the timing controller 11. Then, the data drive circuit 12 converts the digital video data RGB into analog positive/negative polarity gamma voltage in response to the polarity control signal POL to generate positive/negative polarity analog data voltage, and supplies the data voltage to the data lines D1 to Dm/2. As such, the data drive circuit 12 supplies data voltages having different polarities to the proximate data lines D1 to Dm/2 for a first frame period.

The gate drive circuit 14 generates scan pulses to select a horizontal line of the liquid crystal panel 10 to which the analog data voltage will be supplied under control of the timing controller 11, and sequentially supplies the scan pulses to the gate lines G1 to G2n.

Hereinafter, a configuration of the liquid crystal panel 10 according to the embodiment will be described in detail.

FIG. 2 is a plan view showing the liquid crystal panel 10 shown in FIG. 1, and FIG. 3 is an explanatory view of a method of driving the liquid crystal panel 10 shown in FIG. 2.

In FIGS. 2 and 3, positive polarity data voltage is marked by ‘+’, and negative polarity data voltage is marked by ‘−’. In addition, in the following description, only a particular frame in which positive polarity data voltage ‘+’ is applied to odd-numbered data lines and negative polarity data voltage ‘−’ is applied to even-numbered data lines will be described by way of example.

Referring to FIG. 2, sub-pixels have first to fourth colors and are arranged in a stripe form. The sub-pixels are arranged in two columns between every two data lines.

Here, the first color is red R, the second color is green G, the third color is blue B, and the fourth color is white W. Although the first to fourth colors are not limited to RGBW, for convenience of description, the first to fourth colors will hereinafter be described as being RGBW.

The liquid crystal panel 10 includes first and second pixels P1 and P2 as combinations of RGBW sub-pixels. The first and second pixels P1 and P2 are alternately arranged in a column direction and alternately arranged in a row direction.

The first pixels P1 include first to fourth sub-pixels sp1 to sp4.

The first sub-pixels sp1 are connected to odd-numbered data lines D1, D3, D5, . . . at the left side thereof, and connected to even-numbered gate lines G2, G4, G6, . . . , and are red R. The second sub-pixels sp2 are connected to even-numbered data lines D2, D4, D6, . . . at the right side thereof, and connected to odd-numbered gate lines G1, G3, G5, . . . , and are green G. The third sub-pixels sp3 are connected to even-numbered data lines D2, D4, D6, . . . at the left side thereof, and connected to even-numbered gate lines G2, G4, G6, . . . , and are blue B. The fourth sub-pixels sp4 are connected to odd-numbered data lines D3, D5, . . . at the right side thereof, and connected to odd-numbered gate lines G1, G3, G5, . . . , and are white W.

The second pixels P2 include fifth to eighth sub-pixels sp5 to sp8.

The fifth sub-pixels sp5 are connected to even-numbered data lines D2, D4, D6, . . . at the right side thereof, and connected to odd-numbered gate lines G1, G3, G5, . . . , and are red R. The sixth sub-pixels sp6 are connected to odd-numbered data lines D1, D3, D5, . . . at the left side thereof, and connected to even-numbered gate lines G2, G4, G6, . . . , and are green. G. The seventh sub-pixels sp7 are connected to odd-numbered data lines D3, D5,. . . at the right side thereof, and connected to odd-numbered gate lines G1, G3, G5, . . . , and are blue B. The eighth sub-pixels sp8 are connected to even-numbered data lines D2, D4, D6, . . . at the left side thereof, and connected to even-numbered gate lines G2, G4, G6, . . . , and are white W.

Hereinafter, driving of the first and second pixels P1 and P2 will be described with reference to FIG. 3. In FIG. 3, arrows represent the application sequence of data voltage.

In the case of the first pixels P1, data voltage is supplied to the second and fourth sub-pixels sp2 and sp4 in response to scan pulses supplied from the odd-numbered gate lines G1, G3, G5, . . . . More specifically, the second sub-pixels sp2 receive negative polarity data voltage from the even-numbered data lines D2, D4, D6, . . . at the right side thereof in response to scan pulses supplied from the odd-numbered gate lines G1, G3, G5, . . . . The fourth sub-pixels sp4 receive positive polarity data voltage from the odd-numbered data lines D3, D5, . . . at the right side thereof in response to scan pulses supplied from the odd-numbered gate lines G1, G3, G5, . . . .

Subsequently, data voltage is supplied to the first and third sub-pixels sp1 and sp3 of the first pixels P1 in response to scan pulses supplied from the even-numbered gate lines G2, G4, G6, . . . . More specifically, the first sub-pixels sp1 receive positive polarity data voltage from the odd-numbered data lines D1, D3, D5, . . . at the left side thereof in response to scan pulses supplied from the even-numbered gate lines G2, G4, G6, . . . . The third sub-pixels sp3 receive negative polarity data voltage from the even-numbered data lines D2, D4, D6, . . . at the left side thereof in response to scan pulses supplied from the even-numbered gate lines G2, G4, G6, . . . .

In the case of the second pixels P2, data voltage is supplied to the fifth and seventh sub-pixels sp5 and sp7 in response to scan pulses supplied from the odd-numbered gate lines G1, G3, G5, . . . . More specifically, the fifth sub-pixels sp5 receive negative polarity data voltage from the even-numbered data lines D2, D4, D6, . . . at the right side thereof in response to scan pulses supplied from the odd-numbered gate lines G1, G3, G5, . . . . The seventh sub-pixels sp7 receive positive polarity data voltage from the odd-numbered data lines D3, D5, . . . at the right side thereof in response to scan pulses supplied from the odd-numbered gate lines G1, G3, G5, . . . .

Subsequently, data voltage is supplied to the sixth and eighth sub-pixels sp6 and sp8 of the second pixels P2 in response to scan pulses supplied from the even-numbered gate lines G2, G4, G6, . . . . More specifically, the sixth sub-pixels sp6 receive positive polarity data voltage from the odd-numbered data lines D1, D3, D5, . . . at the left side thereof in response to scan pulses supplied from the even-numbered gate lines G2, G4, G6, . . . . The eighth sub-pixels sp8 receive negative polarity data voltage from the even-numbered data lines D2, D4, D6, . . . at the left side thereof in response to scan pulses supplied from the even-numbered gate lines G2, G4, G6, . . . .

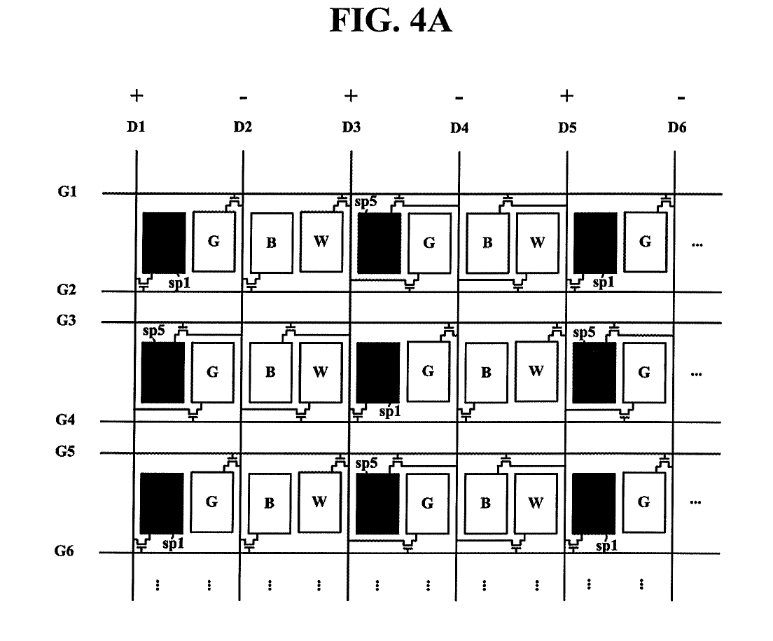

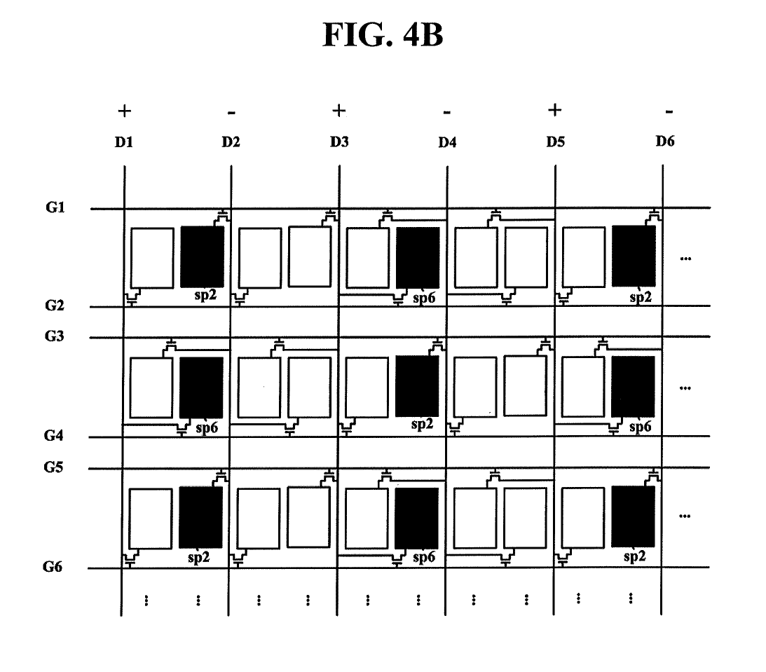

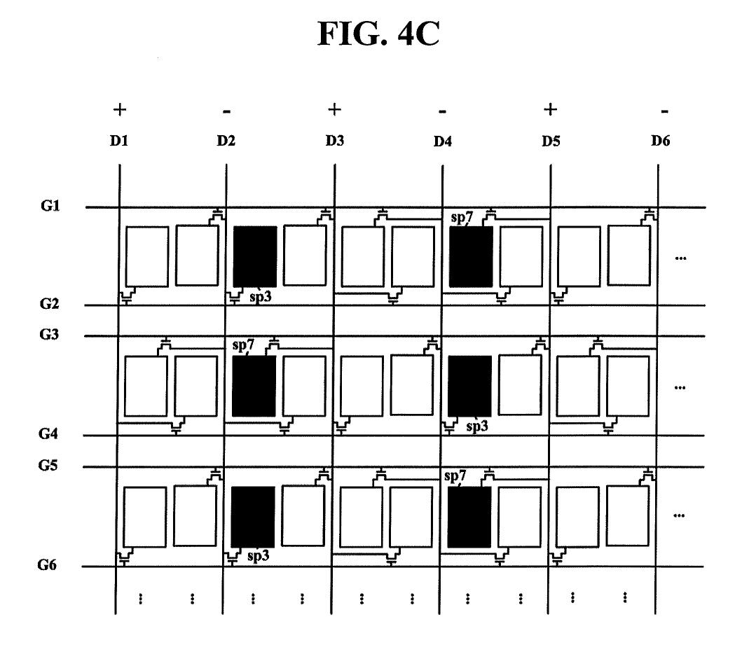

FIGS. 4A to 4C are plan views showing the case in which the liquid crystal panel 10 according to the embodiment displays a monochromic pattern.

Referring to FIG. 4A, in the case of displaying a red pattern, positive polarity data voltage and negative polarity data voltage are alternately supplied in a row direction and in a column direction to the red sub-pixels sp1 and sp5. Referring to FIG. 4B, in the case of displaying a green pattern, positive polarity data voltage and negative polarity data voltage are alternately supplied in a row direction and in a column direction to the green sub-pixels sp2 and sp6. Referring to FIG. 4C, in the case of displaying a blue pattern, positive polarity data voltage and negative polarity data voltage are alternately supplied in a row direction and in a column direction to the blue sub-pixels sp3 and sp7.

As is apparent from the above description, according to the embodiment, upon display of a monochromic pattern, it is possible to prevent the same polarity of data voltage from being applied in a vertical direction or in a horizontal direction, and to prevent line dimming in a vertical direction or in a horizontal direction, thereby achieving enhanced image quality.

It will be apparent that, although the preferred embodiments have been shown and described above, the invention is not limited to the above-described specific embodiments, and various modifications and variations can be made by those skilled in the art without departing from the gist of the appended claims. Thus, it is intended that the modifications and variations should not be understood independently of the technical sprit or prospect of the invention.

What is claimed is:

1. A liquid crystal display device comprising:
m/2 data lines and 2n gate lines that intersect each other to define m×n sub-pixels,
wherein the sub-pixels have first to fourth colors and are arranged in a stripe form,
wherein a first pixel including first to fourth sub-pixels and a second pixel including fifth to eighth sub-pixels are arranged between a first gate line and a second gate line, the first and second sub-pixels are arranged between a first data line and a second data line, the third and fourth sub-pixels are arranged between the second data line and a third data line, the fifth and sixth sub-pixels are arranged between the third data line and a fourth data line, and the seventh and eighth sub-pixels are arranged between the fourth data line and a fifth data line,
wherein the first sub-pixel is connected to the first data line, the second and third sub-pixels are connected to the second data line, the fourth and sixth sub-pixels are connected to the third data line, the fifth and eighth sub-pixels are connected to the fourth data line, and the seventh sub-pixel is connected to the fifth data line, and
wherein the first and second pixels are alternately arranged in a column direction and alternately arranged in a row direction.

2. The device according to claim 1, wherein the first and fifth sub-pixels have the first color, the second and sixth sub-pixels have the second color, the third and seventh sub-pixels have the third color, and the fourth and eighth sub-pixels have the fourth color.

3. The device according to claim 1, wherein data voltages having different polarities are applied to the proximate data lines for a first frame period.

4. The device according to claim 1, wherein the second, fourth, fifth, and seventh sub-pixels are connected to the first gate line, and the first, third, sixth, and eighth sub-pixels are connected to the second gate line.

5. The device according to claim 1, wherein the first color is red, the second color is green, the third color is blue, and the fourth color is white.

6. A method of driving a liquid crystal display device, the method comprising driving m×n sub-pixels arranged in two columns between every two data lines by sequentially supplying scan pulses to 2n gate lines and supplying data voltages to m/2 data lines in synchronization with the scan pulses, the sub-pixels having first to fourth colors and being arranged in a stripe form,
wherein driving of the m×n sub-pixels include driving a first pixel including first to fourth sub-pixels between first and second gate lines, and driving a second pixel including fifth and eighth sub-pixels between the first and second gate lines,
wherein the first and second sub-pixels are arranged between a first data line and a second data line, the third and fourth sub-pixels are arranged between the second data line and a third data line, the fifth and sixth sub-pixels are arranged between the third data line and a fourth data line, and the seventh and eighth sub-pixels are arranged between the fourth data line and a fifth data line,
wherein the first sub-pixel is connected to the first data line, the second and third sub-pixels are connected to the second data line, the fourth and sixth sub-pixels are connected to the third data line, the fifth and eighth sub-pixels are connected to the fourth data line, and the seventh sub-pixel is connected to the fifth data line, and
wherein the first and second pixels are alternately arranged in a column direction and alternately arranged in a row direction.

7. The method according to claim 6, wherein the first and fifth sub-pixels have the first color, the second and sixth sub-pixels have the second color, the third and seventh sub-pixels have the third color, and the fourth and eighth sub-pixels have the fourth color.

8. The method according to claim 6, wherein supply of data voltage to the m/2 data lines include supplying data voltages having different polarities to the proximate data lines for a first frame period.

9. The method according to claim 6, wherein the first color is red, the second color is green, the third color is blue, and the fourth color is white.

10. The method according to claim 6, wherein driving of the first pixel includes supplying data voltage having a first polarity and data voltage having a second polarity to the fourth and second sub-pixels in response to the scan pulse supplied from the first gate line, and subsequently supplying data voltage having the first polarity and data voltage having the second polarity to the first and third sub-pixels in response to the scan pulse supplied from the second gate line, and
wherein driving of the second pixel includes supplying data voltage having the second polarity and data voltage having the first polarity to the fifth and seventh sub-pixels in response to the scan pulse supplied from the first gate line, and subsequently supplying data voltage having the first polarity and data voltage having the second polarity to the sixth and eighth sub-pixels in response to the scan pulse supplied from the second gate line.
